(19) United States
(12) Patent Application Publication
(10) Pub. No.: US 2019/0338159 A1
(43) Pub. Date: Nov. 7, 2019

(54) LOW-REFRACTIVE-INDEX FILM-FORMING LIQUID COMPOSITION AND METHOD OF FORMING LOW-REFRACTIVE-INDEX FILM USING SAME

(71) Applicant: MITSUBISHI MATERIALS CORPORATION, Tokyo (JP)

(72) Inventors: Satoko Higano, Naka-shi (JP); Kazuhiko Yamasaki, Tokyo (JP)

(21) Appl. No.: 16/478,630

(22) PCT Filed: Feb. 28, 2018
(86) PCT No.: PCT/JP2018/007484

§ 371 Date: Jul. 17, 2019

(30) Foreign Application Priority Data
Mar. 8, 2017 (JP) 2017-043546

(51) Int. Cl. C09D 163/00; C09D 7/61; C03C 17/32

(52) U.S. Cl. CPC C09D 163/00; C09D 7/61; C08K 3/36; C03C 2217/73; C03C 17/326

(57) ABSTRACT

According to the present invention, provided is a low-refractive-index film-forming liquid composition including: an epoxy resin (A) having a naphthalene skeleton in a molecular structure; a silica sol (B) in which spherical colloidal silica particles and beaded colloidal silica particles are dispersed in a liquid medium; and an organic solvent (C), in which a SiO₂ content in the silica sol is 100 to 3000 parts by mass with respect to 100 parts by mass of a solid content of the dried and cured epoxy resin.

### TECHNICAL FIELD

The present invention relates to a low-refractive-index film-forming liquid composition including an epoxy resin having a naphthalene skeleton, a silica sol, and an organic solvent and a method of forming a low-refractive-index film using the same. More specifically, the present invention relates to: a liquid composition for forming a low-refractive-index film that has no cracks even in a case where the thickness of the film formed on a transparent body surface is more than 1 μm, has a high film hardness, and can be used as an antireflection film having a refractive index of 1.4 or lower; a method of forming a low-refractive-index film using the same.

Priority is claimed on Japanese Patent Application No. 2017-043546, filed on Mar. 8, 2017, the content of which is incorporated herein by reference.

### BACKGROUND ART

In the related art, as a low-refractive-index film-forming liquid composition including a silica sol, there is disclosed is a coating solution including: a silica sol (a) having a particle size of 5 to 30 nm; and at least one component (b) selected from the group consisting of an alkoxysilane hydrolyzate, a metal alkoxide hydrolyzate, and a metal salt, in which the content of the component (b) in an organic solvent in terms of a metal oxide is 10 to 50 parts by weight with respect to 100 parts by mass of SiO₂ of the silica sol (a) (for example, refer to PTL 1). The silica sol included in the coating solution includes a solid content having a concentration of 5 to 50 wt % as SiO₂.

According to this coating solution, a low-refractive-index antireflection film having a superior mechanical strength and a high adhesive strength with a base material can be obtained.

On the other hand, as a composition that includes an epoxy resin having a naphthalene skeleton, there is disclosed an epoxy resin composition for a fiber reinforced composite material, the composition including: an epoxy resin (hereinafter, referred to as “special epoxy resin”) that includes an epoxy resin having at least one selected from a naphthalene skeleton and a dicyclopentadiene skeleton as a fused cyclic structure; and dispersed colloidal silica nanoparticles (for example, refer to PTL 2). PTL 2 describes that the dispersed colloidal silica nanoparticles included in the epoxy resin composition are silica microparticles that are dispersed in a liquid of the epoxy resin or the like due to the action of surface charge or the like without aggregating. In addition, PTL 2 describes that a preferable blending amount of the dispersed colloidal silica nanoparticles is 2 to 40 parts by mass with respect to 100 parts by mass of the epoxy resin component, in a case where the blending amount of the dispersed colloidal silica nanoparticles is 2 parts by mass or more, the elastic modulus of the epoxy resin composition can be improved, and in a case where the blending amount of the dispersed colloidal silica nanoparticles increases, it is difficult to maintain a good dispersed state in the epoxy resin. Further, PTL 2 describes that, by adjusting the blending amount of the dispersed colloidal silica nanoparticles to be 40 parts by mass or less with respect to 100 parts by mass of the epoxy resin component, the dispersibility of the silica microparticles in the epoxy resin can be maintained. This epoxy resin composition exhibits high elastic modulus, high heat resistance, and high toughness as a matrix resin for a fiber reinforced composite material and exhibits high tensile strength and high adhesiveness with carbon fibers as a fiber reinforced composite material.

### CITATION LIST

### Patent Literature

[PTL 1] Japanese Unexamined Patent Application, First Publication No. H8-122501 (claim 1 and paragraph [0006])
[PTL 2] Japanese Unexamined Patent Application, First Publication No. 2010-202727 (claim 1, claim 5, paragraph [0019], paragraph [0021], and paragraph [0040])

### SUMMARY OF INVENTION

### Technical Problem

In a case where the coating solution as the low-refractive-index film-forming liquid composition disclosed in PTL 1 is applied to the transparent body surface and cured to form a low-refractive-index film having a thickness of more than 1 μm, at least one component selected from the group consisting of an alkoxysilane hydrolyzate, a metal alkoxide hydrolyzate, and a metal salt included in the coating solution shrinks in the process of forming the film. Therefore, there is a problem in that cracks are formed in the film due to the shrinkage stress.

On the other hand, the epoxy resin composition disclosed in PTL 2 has a function as a matrix resin for a fiber reinforced composite material and is used for obtaining a fiber reinforced composite material by impregnating the epoxy resin composition with reinforced fibers and heating the epoxy resin composition to be cured. In the epoxy resin composition disclosed in PTL 2, in order to make the epoxy resin function as the matrix resin, the dispersed colloidal silica nanoparticles are dispersed such that the content thereof was low at 2 to 40 parts by mass with respect to 100 parts by mass of the epoxy resin component. PTL 2 describes that, in a case where the blending amount of the silica microparticles increases, it is difficult to maintain a good dispersed state in the epoxy resin. The low-refractive-index film-forming liquid composition according to the present invention also includes an epoxy resin having a naphthalene skeleton and silica particles but is configured to be rich in silica sol such that the content of the silica sol is higher than that of the epoxy resin. Therefore, in a case where the blending ratio between the epoxy resin and the silica particles is adjusted as in the epoxy resin composition disclosed in PTL 2, the blending ratio is suitable for forming a fiber reinforced composite material, but there is a problem in that a liquid composition for forming a low-refractive-index film that has no cracks, has a high film hardness, and can be used as an antireflection film having a refractive index of 1.4 or lower cannot be realized.

An object of the present invention is to provide: a liquid composition for forming a low-refractive-index film that has no cracks even in a case where the thickness of the film formed on a transparent body surface is more than 1 μm, has a high film hardness, and can be used as an antireflection film having a refractive index of 1.4 or lower; a method of forming a low-refractive-index film using the same.

### Solution to Problem

According to a first aspect of the present invention, there is provided a low-refractive-index film-forming liquid composition including: an epoxy resin (A) having a naphthalene skeleton in a molecular structure; a silica sol (B) in which spherical colloidal silica particles and beaded colloidal silica particles are dispersed in a liquid medium; and an organic solvent (C), in which a SiO₂ content in the silica sol is 100 to 3000 parts by mass with respect to 100 parts by mass of a solid content of the dried and cured epoxy resin.

According to a second aspect of the present invention, there is provided a method of forming a low-refractive-index film, the method including: applying the low-refractive-index film-forming liquid composition according to the first aspect to a transparent body surface.

According to a third aspect of the present invention, there is provided a method of manufacturing a transparent body with a low-refractive-index film, the method including: forming the low-refractive-index film on a body surface using the method according to the second aspect.

### Advantageous Effects of Invention

The low-refractive-index film-forming liquid composition according to the first aspect of the present invention is configured to be rich in silica sol such that the content of the silica sol is higher than that of the epoxy resin, and in the silica sol, spherical colloidal silica particles and beaded colloidal silica particles are dispersed in the liquid medium. Therefore, in a case where the liquid composition is applied to the transparent body and cured to form a low-refractive-index film, unevenness including micropores is formed on the transparent body surface, and a low-refractive-index film having a refractive index of 1.4 or lower can be formed. In addition, the epoxy resin having a naphthalene skeleton in a molecular structure has superior miscibility with the silica sol. That is, even in a case where the epoxy resin is mixed with the silica sol, the epoxy resin itself is dissolved, and the dispersion stability of the silica sol does not deteriorate. Therefore, the silica particles do not aggregate. Thus, it is possible to form a low-refractive-index film that has no cracks even in a case where the thickness of the formed film is more than 1 μm, has a high film hardness and high transparency, and can be used as an antireflection film.

In the method of forming a low-refractive-index film according to the second aspect of the present invention, a low-refractive-index film is formed using the low-refractive-index film-forming liquid composition. Therefore, the formed low-refractive-index film has a low refractive index of 1.4 or lower, and even in a case where the thickness of the film is more than 1 μm, cracks are not formed in the formed film, and the film hardness and the transparency are high.

In the method of manufacturing a transparent body with a low-refractive-index film according to the third aspect of the present invention, it is possible to obtain a transparent body to which a low-refractive-index film that has a thickness of more than 1 μm, has no cracks, has a high film hardness and high transparency, and has a low refractive index of 1.4 or lower is bonded.

### BRIEF DESCRIPTION OF DRAWINGS

FIG. 1 is a cross-sectional view illustrating a glass with a low-refractive-index film in which the low-refractive-index film is formed on a transparent glass substrate surface using a low-refractive-index film-forming liquid composition according to an embodiment of the present invention.

FIG. 2 is a cross-sectional view illustrating a resin film with a low-refractive-index film in which the low-refractive-index film is formed on a transparent resin film surface using the low-refractive-index film-forming liquid composition according to the embodiment.

### DESCRIPTION OF EMBODIMENTS

Next, an embodiment of the present invention will be described.

### [Epoxy Resin (A) Having Naphthalene Skeleton in Molecular Structure]

PTL 2 discloses an epoxy resin composition as a matrix resin for a fiber reinforced composite material. However, the epoxy resin according to the embodiment is different from the epoxy resin of PTL 2. The epoxy resin (A) having a naphthalene skeleton in a molecular structure is a component (hereinafter, referred to as “binder component”) of the liquid composition according to the embodiment, causes the low-refractive-index film to be bonded to a base body, and forms a skeleton component of the low-refractive-index film. The epoxy resin (A) having a naphthalene skeleton in a molecular structure according to the embodiment is an epoxy resin that has a skeleton including at least one naphthalene ring in one molecule, and examples thereof include a naphthol epoxy resin and a naphthalenediol epoxy resin. Examples of the naphthalene type epoxy resin include 1,3-diglycidyl ether naphthalene, 1,4-diglycidyl ether naphthalene, 1,5-diglycidyl ether naphthalene, 1,6-diglycidyl ether naphthalene, 2,6-diglycidyl ether naphthalene, 2,7-diglycidyl ether naphthalene, 1,3-diglycidyl ester naphthalene, 1,4-diglycidyl ester naphthalene, 1,5-diglycidyl ester naphthalene, 1,6-diglycidyl ester naphthalene, 2,6-diglycidyl ester naphthalene, 2,7-diglycidyl ester naphthalene, 1,3-tetraglycidyl amine naphthalene, 1,4-tetraglycidyl amine naphthalene, 1,5-tetraglycidyl amine naphthalene, 1,6-tetraglycidyl amine naphthalene, 1,8-tetraglycidyl amine naphthalene, 2,6-tetraglycidyl amine naphthalene, and 2,7-tetraglycidyl amine naphthalene. The epoxy resin having a naphthalene skeleton in a molecular structure is not particularly limited as long as it includes the above-described naphthalene type epoxy resin. As the epoxy resin having a naphthalene skeleton in a molecular structure, one kind may be used alone or two or more kinds may be used in combination. In particular, a liquid (liquid at 25° C.) bifunctional naphthalene type epoxy resin is preferable from the viewpoint of a low viscosity. The liquid epoxy resin and a solid epoxy resin may be used in combination. By using the epoxy resin having a naphthalene skeleton in a molecular structure, the liquid composition can be used for forming a low-refractive-index film that has no cracks even in a case where the thickness is more than 1 μm and has a high film hardness. Preferable examples of the naphthalene type epoxy resin include 1,4-diglycidyl ether naphthalene, 1,6-diglycidyl ether naphthalene, 1,4-diglycidyl ester naphthalene, and 1,8-tetraglycidyl amine naphthalene.

### [Silica Sol (B)]

The silica sol (B) according to the embodiment is a sol in which spherical colloidal silica particles and beaded colloidal silica particles are dispersed in a liquid medium. In general, as the silica particles included in the silica sol, for example, not only beaded silica particles but also spherical, acicular, or plate-like silica particles are widely known. In the embodiment, the silica sol in which both of the spherical colloidal silica particles and the beaded colloidal silica particles are dispersed is used. In a case where only the spherical colloidal silica particles are used, the refractive index of the coating film is not sufficiently reduced. In a case where only the beaded colloidal silica particles are used, the hardness of the coating film is low. Therefore, the silica sol in which both of the spherical colloidal silica particles and the beaded colloidal silica particles are dispersed is used.

The average particle size of the spherical colloidal silica particles is preferably 2 to 80 nm. In a case where the average particle size of the spherical colloidal silica particles is 2 nm or less, the spherical colloidal silica particles are not likely to be in a monodispersed state and are likely to be in an aggregated state. In a case where the average particle size of the spherical colloidal silica particles is 80 nm or more, the unevenness of a surface of the coating film increases, and the haze of the film is likely to increase. On the other hand, the beaded colloidal silica particles are obtained by bonding a plurality of spherical colloidal silica particles having an average particle size of 5 to 50 nm using a metal oxide-containing silica. Here, the reason why the average particle size of the spherical colloidal silica particles constituting the beaded colloidal silica particles is set to be in the above-described range is as follows. In a case where the average particle size is lower than the lower limit value, the refractive index of the formed film is not likely to sufficiently decrease. On the other hand, in a case where the average particle size is higher than the upper limit value, the haze of the film is likely to increase due to the unevenness of the film surface. In particular, it is more preferable that the average particle size of the spherical colloidal silica particles constituting the beaded colloidal silica particles is in a range of 5 to 30 nm. The average particle size of the spherical colloidal silica particles refers to a particle size that is obtained by observing particle shapes at 200 points with a TEM, measuring particle sizes thereof, and obtaining an average value thereof. In addition, examples of the metal oxide-containing silica that bond the spherical colloidal silica particles to each other include amorphous silica and amorphous alumina.

In the silica sol according to the embodiment, the SiO₂ concentration is preferably 5 to 40 mass %. In a case where the SiO₂ concentration in the silica sol is lower than 5 mass %, the refractive index of the formed film may insufficiently decrease. On the other hand, in a case where the SiO₂ concentration in the silica sol is higher than 40 mass %, SiO₂ in the silica sol is likely to aggregate such that the liquid may be unstable. The SiO₂ concentration in the silica sol is more preferably 10 to 30 mass %.

The content of the spherical colloidal silica particles according to the embodiment is preferably 0.5 to 30 mass % with respect to a component (hereinafter, referred to as “the solid content of the silica sol”) when the silica sol is dried and cured, and the content of the beaded colloidal silica particles is preferably 70 to 99.5 mass % with respect to the solid content of the silica sol. The reason for this is to obtain a low refractive index and a high film hardness of the film. As the content of the beaded colloidal silica particles increases, the refractive index of the film decreases. By the silica sol including the two kinds of colloidal silica particles, the refractive index of the film can be easily adjusted. On the other hand, in a case where only the beaded colloidal silica particles are used, the film hardness of the coating film is weak. Therefore, it is preferable that the silica sol includes the spherical colloidal silica particles.

The spherical colloidal silica particles in the silica sol according to the embodiment can be prepared using a water glass method including: preparing activated silica by ion exchange of sodium silicate; and adding the prepared activated silica to a seed particle-containing aqueous solution in which the pH is adjusted with NaOH under heating such that the particles are caused to grow. In the embodiment, for example, a silica sol described in Japanese Unexamined Patent Application, First Publication No. S61-158810 can also be used. In Japanese Unexamined Patent Application, First Publication No. S61-158810, an alkali silicate aqueous solution having a concentration of 0.5 to 7 mass % is brought into contact with a strongly acidic cation-exchange resin for dealkalization to prepare a silica solution. By adding an acid to the silica solution to acidize the silica solution at a pH of 2.5 or lower and a temperature of 0 to 98° C., an acidic colloidal silica solution is obtained. Impurities in the obtained acidic colloidal silica solution are removed to prepare an oligo-silicic acid solution. Ammonia or amine is added to a part of the oligo-silicic acid solution, and the solution is heated at a pH of 7 to 10 and a temperature of 60° C. to 98° C. to prepare a heel-sol. By slowing dropping the balance of the oligo-silicic acid solution on the heel-sol, colloidal particles are caused to grow, and a silica sol is obtained.

In addition, the spherical colloidal silica particles can be prepared using an alkoxide method, in particular, a so-called Stoeber method including: hydrolyzing an alkyl silicate (tetraalkoxysilane) in the presence of a basic catalyst; and producing silica particles while performing condensation and particle growth. In the embodiment, for example, a high-purity spherical silica described in Japanese Unexamined Patent Application, First Publication No. S63-291807 can also be used. In Japanese Unexamined Patent Application, First Publication No. S63-291807, a silicic acid ester and water are caused to react with each other in the presence of an acid or an alkali catalyst to produce a silica gel, and the produced silica gel is separated and then is dried and sintered. As a result, a synthetic silica is produced. At this time, while causing an organic solvent having no compatibility with water and a nonionic surfactant to be present in the mixed solution including the silicic acid ester, water, and the catalyst to form a water-in-oil emulsion, a silica gel is produced.

It is preferable that the beaded colloidal silica particles in the silica sol according to the embodiment are obtained by bonding a plurality of spherical silica particles to each other using a bonding part of a metal oxide-containing silica or the like. The beaded colloidal silica particles can be obtained by undergoing a process of further producing spherical silica particles with a water glass method using an acidic sol including the spherical colloidal silica particles prepared as described above such that the spherical silica particles are bonded using a metal oxide-containing silica or the like. As the silica sol in which the beaded colloidal silica particles are dispersed, for example, a silica sol described in Japanese Patent No. 4328935 can be used. The silica sol described in Japanese Patent No. 4328935 has a SiO₂ concentration of 50 wt % or lower and is a stable sol. The shape of the colloidal silica particles dispersed in the liquid medium of the silica sol has a size of 50 to 500 nm as a particle size D₁ measured using a dynamic light scattering method. When observed with an electron microscope, the particles include: spherical colloidal silica particles; and a silica to which the spherical colloidal silica particles are bonded, and have a shape in which the spherical colloidal silica particles are bonded to only one plane. In the beaded colloidal silica particles, the value of D₁/D₂ as a degree of bonding is 3 or higher, D₁/D₂ being a ratio of an average particle size D₂ (average particle size that is obtained from the expression “D2=2720/S” based on a specific surface area Sm²/g measured using a nitrogen gas adsorption method) of the spherical colloidal silica particles to D₁. The above-described method of producing the spherical colloidal silica particles and the beaded colloidal silica particles are merely exemplary, and the present invention is not limited to the above-described methods. The spherical colloidal silica particles and the beaded colloidal silica particles can be produced using various methods.

### [Liquid Medium]

As the liquid medium of the silica sol according to the embodiment, that is, as a dispersion medium of the silica sol, the same medium as an organic solvent described below is preferable, but the present invention is not limited thereto. In a case where the liquid medium is an organic solvent, the silica sol becomes organosilica sol, becomes active due to silanol groups present on the colloidal silica particle surfaces, and finally and irreversibly changes to a silica gel as the medium is removed. Examples of the organic solvent that is the liquid medium of the organosilica sol include the following organic solvent that does not interfere with the activity of the colloidal silica particles.

### [Organic Solvent (C)]

As described above, the silica sol includes a liquid solvent. The reason why the low-refractive-index film-forming liquid composition according to the embodiment includes an organic solvent in addition to the liquid solvent is to adjust the transparency of the low-refractive-index film, the thickness thereof, and the adhesiveness thereof with a base material. Therefore, the organic solvent is widely selected from the liquid solvent of the silica sol and other solvents. It is preferable that an alcohol, a ketone, a glycol ether, or a glycol ether acetate is used as the organic solvent (C) according to the embodiment. In order to improve the application properties of the finally obtained low-refractive-index film-forming liquid composition, it is more preferable that an alcohol, a glycol ether, or a glycol ether acetate is used as the organic solvent (C) according to the embodiment.

Examples of the alcohol include methanol, ethanol, propanol, and isopropyl alcohol (IPA). In addition, examples of the ketone include acetone, methyl ethyl ketone (MEK), and methyl isobutyl ketone (MIBK). In addition, examples of the glycol ether include ethylene glycol monomethyl ether, diethylene glycol monomethyl ether, propylene glycol monomethyl ether, dipropylene glycol monomethyl ether, ethylene glycol monoethyl ether, diethylene glycol monoethyl ether, propylene glycol monoethyl ether, dipropylene glycol monoethyl ether, triethylene glycol monobutyl ether, tetraethylene glycol dimethyl ether, and polyethylene glycol dimethyl ether. In addition, examples of the glycol ether acetate include ethylene glycol monomethyl ether acetate, diethylene glycol monomethyl ether acetate, propylene glycol monomethyl ether acetate, dipropylene glycol monomethyl ether acetate, ethylene glycol monoethyl ether acetate, diethylene glycol monomethyl ether acetate, propylene glycol monoethyl ether acetate, dipropylene glycol monoethyl ether acetate, and polyethylene glycol monomethyl ether acetate. Among these, from the viewpoint of obtaining superior application properties during film formation, ethanol, IPA, MEK, MIBK, ethylene glycol monomethyl ether, ethylene glycol monomethyl ether acetate, propylene glycol monomethyl ether, dipropylene glycol monomethyl ether, or propylene glycol monomethyl ether acetate is more preferable.

In addition, the content of the organic solvent varies depending on the desired thickness of the film. The content of the organic solvent is preferably 0.5 to 90 parts by mass with respect to 100 parts by mass of the low-refractive-index film-forming liquid composition. In a case where the content of the organic solvent is less than the lower limit value, the application properties of the low-refractive-index film-forming liquid composition to the transparent body are poor, and it is difficult to obtain a uniform low-refractive-index film. On the other hand, in a case where the content of the organic solvent is higher than the upper limit value, the thickness of the film is reduced, and it is difficult to exhibit an antireflection function. In particular, the proportion of the organic solvent is more preferably 1 to 80 parts by mass.

### [Method of Preparing Low-Refractive-Index Film-Forming Liquid Composition]

The low-refractive-index film-forming liquid composition according to the embodiment is prepared using a method including: mixing the epoxy resin (A) having a naphthalene skeleton in a molecular structure and the silica sol (B) in which spherical colloidal silica particles and beaded colloidal silica particles are dispersed in a liquid medium with each other to prepare a mixed solution; and mixing the organic solvent (C) with the mixed solution. Here, the epoxy resin (A) and the silica sol (B) are mixed such that the SiO₂ content in the silica sol is 100 to 3000 parts by mass, preferably 300 to 2000 parts by mass, more preferably 500 to 2000 parts by mass, and still more preferably 1000 to 1700 parts by mass with respect to 100 parts by mass of the solid content of the dried and cured epoxy resin (hereinafter, referred to as “the solid content of the epoxy resin” or “the binder solid content”). In a case where the SiO₂ content in the silica sol is lower than 100 parts by mass, the refractive index of the formed film may insufficiently decrease. On the other hand, in a case where the SiO₂ content in the silica sol is higher than 3000 parts by mass, the component is insufficient, and thus the film hardness decreases. As a method of determining the SiO₂ content, before mixing the epoxy resin (A) and the silica sol (B), the amount of the solid content (SiO₂ content) after sintering the silica sol (B) at 650° C. for 30 minutes is obtained in advance. Next, the epoxy resin (A) and the silica sol (B) are mixed with each other such that the SiO₂ content is in the predetermined range based on the SiO₂ content in the silica sol (B).

### [Method of Forming Low-Refractive-Index Film]

A low-refractive-index film is formed by applying the low-refractive-index film-forming liquid composition prepared as described above to a transparent body surface. Examples of the transparent body include a transparent glass substrate, a transparent resin substrate, and a transparent resin film. Examples of the glass of the glass substrate include a glass having a high visible transmittance such as clear glass, high transmittance glass, soda-lime glass, or green glass. Examples of the resin of the resin substrate or the resin film include an acrylic resin such as polymethyl methacrylate, an aromatic polycarbonate resin such as polyphenylene carbonate, and an aromatic polyester resin such as polyethylene terephthalate (PET).

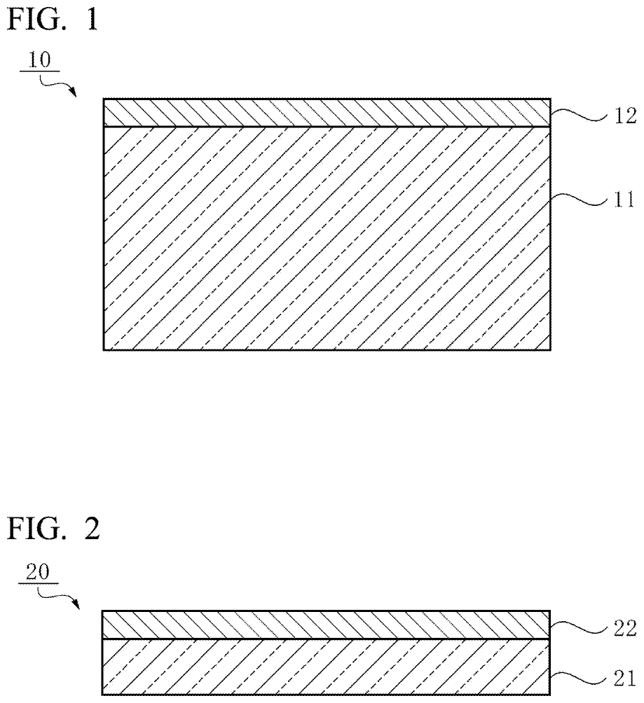

By applying the low-refractive-index film-forming liquid composition to the transparent body surface, drying the applied low-refractive-index film-forming liquid composition at a predetermined temperature, and heating the dried low-refractive-index film-forming liquid composition, a low-refractive-index film having a thickness of 0.1 to 2.0 μm and preferably 0.6 to 1.2 μm and having no cracks can be formed on the transparent body surface. That is, even in a case where the thickness of the film is more than 1 μm, a low-refractive-index film having no cracks can be formed. Examples of a method of applying the low-refractive-index film-forming liquid composition include a spin coating method, a die coating method, and a spraying method. When the low-refractive-index film-forming liquid composition is dried, the temperature may be 40° C. to 300° C., and the time may be 5 to 120 minutes. However, the present invention is not limited to this example. In a case where the transparent body is a transparent glass substrate, the heat treatment is performed by holding the composition in an oxygen atmosphere at a temperature of 50° C. to 300° C. for 5 to 60 minutes. The temperature and the holding time are determined depending on the required film hardness. This way, as illustrated in FIG. 1, a glass 10 with a low-refractive-index film in which a low-refractive-index film 12 is formed on a surface of a transparent glass substrate 11 is formed. In addition, in a case where the transparent body is a transparent resin film, the heat treatment is performed by holding the composition in an oxygen atmosphere at a temperature of 40° C. to 120° C. for 5 to 120 minutes. The temperature and the holding time are determined depending on the required film hardness and the heat resistance of a base film. This way, as illustrated in FIG. 2, a resin film 20 with a low-refractive-index film in which a low-refractive-index film 22 is formed on a surface of a transparent resin film 21 is formed. In a case where the thickness of the low-refractive-index film 12 or 22 is less than 0.1 μm, there is a problem in that reflection from the transparent body cannot be sufficiently suppressed. In a case where the thickness of the low-refractive-index film 12 or 22 is more than 2.0 μm, stress concentrates on the inside of the film such that there is a problem in that cracks are likely to be formed.

### EXAMPLES

Next, examples of the present invention and comparative examples will be described in detail.

### [Seven Kinds of Resins]

Table 1 shows seven kinds of resins used in Examples 1 to 8 according to the present invention and Comparative Examples 2 to 6. As epoxy resins having a naphthalene skeleton in a molecular structure, Table 1 shows J1: EXA-4700 (manufactured by DIC Corporation), J2: HP-4700 (manufactured by DIC Corporation), J3: HP-4710 (manufactured by DIC Corporation), J4: HP-6000 (manufactured by DIC Corporation), and J5: HP-4032SS (manufactured by DIC Corporation). As an epoxy resin not having a naphthalene skeleton, Table 1 shows J6: EPICLON 850 (manufactured by DIC Corporation). As a resin that is not an epoxy resin, Table 1 shows an acrylic resin J7: ACRYDIC A-9585 (manufactured by DIC Corporation).

TABLE 1

| Kind | Content of Resin | |
|---|---|---|
| J1 | Epoxy Resin 1 having Naphthalene Skeleton | EXA-4700 |
| J2 | Epoxy Resin 2 having Naphthalene Skeleton | HP-4700 |
| J3 | Epoxy Resin 3 having Naphthalene Skeleton | HP-4710 |
| J4 | Epoxy Resin 4 having Naphthalene Skeleton | HP-6000 |
| J5 | Epoxy Resin 5 having Naphthalene Skeleton | HP-4032SS |
| J6 | Epoxy Resin not having Naphthalene Skeleton | EPICLON 850 |
| J7 | Acrylic Resin | ACRYDIC |
| | | A-9585 |

### Example 1

A binder component J1: EXA-4700 (manufactured by DIC Corporation) as the epoxy resin having a naphthalene skeleton in a molecular skeleton was mixed with a silica sol in which spherical colloidal silica particles and beaded colloidal silica particles were dispersed in a liquid medium of propylene glycol monomethyl ether (hereinafter, referred to as “PGME”). At this time, the mixing ratio between the binder component and the silica sol was adjusted the SiO₂ content in the silica sol was 2000 parts by mass with respect to 100 parts by mass of the component of the dried and cured epoxy resin as the binder component, that is, the binder solid content. This ratio is shown in the following Table 2 as (SiO₂ Content in Silica Sol/Binder Solid Content). In Example 1, the ratio was 20/1. In order to adjust the viscosity of the mixed solution to be suitable for application, PGME as an organic solvent was added to prepare a low-refractive-index film-forming liquid composition. PGME for adjusting the viscosity was added such that the content thereof was 10 mass % with respect to 100 mass % of the low-refractive-index film-forming liquid composition.

### Examples 2 to 8 and Comparative Examples 1 to 6

Resins as binder components according to Examples 2 to 8 and Comparative Examples 2 to 6 were selected as shown in the following Table 2 from the kinds of resins shown in Table 1. On the other hand, as a binder component according to Comparative Example 1, a silicon alkoxide hydrolyzate was selected. This silicon alkoxide hydrolyzate was obtained by using tetramethoxysilane as the silicon alkoxide, adding 1.2 parts by mass of water, 0.02 parts by mass of formic acid, 2.0 parts by mass of isopropyl alcohol (IPA) as an organic solvent with respect to 1 part by mass of tetramethoxysilane, and stirring the components at 55° C. for 1 hour.

In Examples 2 to 8, Comparative Examples 1 to 3, and Comparative Examples 5 and 6, a silica sol in which spherical colloidal silica particles and beaded colloidal silica particles were dispersed in a liquid medium of PGME was used. On the other hand, in Comparative Example 4, a silica sol in which spherical colloidal silica particles were dispersed in a liquid medium of PGME was used. In addition, in Examples 2 to 8 and Comparative Examples 2 to 6, the binder component of the resin and the silica sol were mixed with each other such that the ratio (SiO₂ Content in Silica Sol/Binder Solid Content) was as shown in Table 2. In Comparative Example 5, the silica particles were blended such that the content thereof was the highest in the range described in claim 5 of PTL 2. Specifically, the silica particles and the epoxy resin were blended such that the content of the epoxy resin was 100 parts by mass, the content of the silica particles was 40 parts by mass and the content of the special epoxy resin was 5 parts by mass. In this blending ratio, (SiO₂ Content in Silica Sol/Binder Solid Content) was 40/105 and was shown as 8/21 in Table 2. In Comparative Example 1, the binder component of the silicon alkoxide hydrolyzate and the silica sol were mixed with each other such that the ratio (SiO₂ Content in Silica Sol/Binder Solid Content) was as shown in Table 2 and the ratio of the solid content with respect to the cured and dried silicon alkoxide hydrolyzate was as shown in Table 2.

Further, in Examples 2 to 8 and Comparative Examples 1 to 6, solvents shown in Table 2 was selected as the liquid solvent of the silica sol and the organic solvent for mixing the binder component and the silica sol with each other. Specifically, in Examples 2, 3, 5, and 6 and Comparative Examples 1 to 6, PGME was used as the solvent. In Examples 4 and 8, propylene glycol 1-monomethyl ether 2-acetate (PGMEA) was used as the solvent. In addition, in Example 7, methyl ethyl ketone (MEK) was used as the solvent. The organic solvent for adjusting the viscosity of the low-refractive-index film-forming liquid composition was added at the same ratio as that of Example 1.

TABLE 2

| | Low-Refractive-Index Film-Forming Liquid Composition | | | | | | | | | |
|---|---|---|---|---|---|---|---|---|---|---|
| | | | | SiO₂ Content | | | | | | |
| | | | | in Silica | | | | | | |
| | Binder Component | | Form of | Sol/Binder | | Evaluation | | | | |
| | | Naphthalene | Silica | Solid | Organic | Thickness | Visible | Refractive | Cracks of | Film |
| | Kind | Skeleton | Particles | Content | Solvent | (μm) | Transmittance | Index | Film | Hardness |
| Example 1 | J1 | Present | Spherical + | 20/1 | PGME | 0.9 | Fair | 1.31 | None | 2H |
| | | | Beaded | | | | | | | |
| Example 2 | J2 | Present | Spherical + | 15/1 | PGME | 0.7 | Good | 1.23 | None | 2H |
| | | | Beaded | | | | | | | |
| Example 3 | J3 | Present | Spherical + | 9/1 | PGME | 1.5 | Good | 1.29 | None | 3H |
| | | | Beaded | | | | | | | |
| Example 4 | J4 | Present | Spherical + | 3/1 | PGMEA | 1.2 | Good | 1.25 | None | 2H |
| | | | Beaded | | | | | | | |
| Example 5 | J5 | Present | Spherical + | 1/1 | PGME | 2.0 | Good | 1.35 | None | 2H |
| | | | Beaded | | | | | | | |
| Example 6 | J1 | Present | Spherical + | 30/1 | PGME | 0.6 | Good | 1.21 | None | H |
| | | | Beaded | | | | | | | |
| Example 7 | J2 | Present | Spherical + | 17/1 | MEK | 0.8 | Good | 1.24 | None | 2H |
| | | | Beaded | | | | | | | |
| Example 8 | J2 | Present | Spherical + | 9/1 | PGMEA | 1.0 | Good | 1.36 | None | 2H |
| | | | Beaded | | | | | | | |
| Comparative | Silicon | None | Spherical + | 20/1 | PGME | 0.7 | Good | 1.21 | Present | F |
| Example 1 | Alkoxide | | Beaded | | | | | | | |
| | Hydrolyzate | | | | | | | | | |
| Comparative | J6 | None | Spherical + | 9/1 | PGME | 1.5 | Fair | 1.43 | None | B |
| Example 2 | | | Beaded | | | | | | | |
| Comparative | J7 | None | Spherical + | 9/1 | PGME | 1.5 | Fair | 1.47 | None | HB |
| Example 3 | | | Beaded | | | | | | | |
| Comparative | J1 | Present | Spherical | 9/1 | PGME | 1.5 | Fair | 1.45 | None | H |
| Example 4 | | | Only | | | | | | | |
| Comparative | J1 | Present | Spherical + | 8/21 | PGME | 1.5 | Fair | 1.55 | None | H |
| Example 5 | | | Beaded | | | | | | | |
| Comparative | J1 | Present | Spherical + | 9/10 | PGME | 1.5 | Fair | 1.53 | None | H |
| Example 6 | | | Beaded | | | | | | | |

### <Comparative Test and Evaluation>

Each of the low-refractive-index film-forming liquid compositions according to Examples 1 to 8 and Comparative Examples 1 to 6 was applied using a spin coating method to a transparent soda-lime glass substrate surface having a size of 50 mm×50 mm and a thickness of 0.7 mm at a rotational speed of 1000 rpm for 60 seconds, was dried at 130° C. for 20 minutes, and was sintered at 200° C. for 5 minutes. As a result, 14 kinds of glasses with a low-refractive-index film for evaluation were obtained. Regarding the 14 kinds of low-refractive-index films formed on the glass substrate surfaces, the thickness of the film, the visible transmittance, the refractive index, whether or cracks were formed in the film, and the film hardness were evaluated using the following methods. The results are shown in Table 2.

### (1) Thickness of Film

The thickness of the film was measured by observing a cross-section with an electron scanning microscope (SU-8000, manufactured by Hitachi High-Technologies Corporation).

### (2) Visible Transmittance

Using a spectrophotometer (U-4100, manufactured by Hitachi High-Technologies Corporation), the visible transmittance at a wavelength of 450 nm was measured according to the standard (JIS R 3216-1998). In the evaluation of the visible transmittance, a case where the transmittance of the glass with a low-refractive-index film at a wavelength of 450 nm was 93% or higher was evaluated as “Good”, a case where the transmittance of the glass with a low-refractive-index film at a wavelength of 450 nm was 90% or higher and lower than 93% was evaluated as “Fair”, and a case where the transmittance of the glass with a low-refractive-index film at a wavelength of 450 nm was lower than 90% was evaluated as “Bad”.

### (3) Refractive Index

As the refractive index, a value at 633 nm was used among optical constant values measured and analyzed using a spectroscopic ellipsometer (M-2000, manufactured by J. A. Woollam Japan Corporation).

(4) Whether or not Cracks were Formed in Film

Whether or not cracks were formed in the film were determined by observing a range of 1 cm×1 cm by visual inspection and using a stereoscopic microscope (magnification: 50-fold). A case where no cracks were observed by visual inspection and using the stereoscopic microscope was evaluated as “Good”, a case where cracks were not able to be observed by visual inspection but three or less cracks having a size of 10 μm or less were observed using the stereoscopic microscope was evaluated as “Fair”, and a case where cracks were able to be observed by visual inspection and using the stereoscopic microscope was evaluated as “Bad”.

### (5) Film Hardness

The hardness was measured using a pencil for a test defined in JIS-S6006 according to a pencil hardness evaluation method defined in JIS-K5400 by repeatedly scratching a predetermined surface with a pencil having each hardness three times using a 750-g weight until one scratch was formed. As the number increases, the hardness increases. The evaluation H or more represents that the film hardness is superior, and the evaluation lower than H (F, HB, B) represents that the film hardness was poor.

As can be seen from Table 2, in Comparative Example 1, the silicon alkoxide hydrolyzate was used as the binder component. Therefore, the refractive index of the low-refractive-index film was low at 1.21. In addition, even in a case where the thickness of the film was 0.7 μm, cracks were formed, and the film hardness was poor at “F”.

In Comparative Example 2, the epoxy resin not having a naphthalene skeleton was used as the binder component. Therefore, even in a case where the thickness of the low-refractive-index film was 1.5 cracks were not formed. However, the refractive index was high at 1.43, and the film hardness was poor at “B”.

In comparative Example 3, the acrylic resin was used as the binder component. Therefore, even in a case where the thickness of the low-refractive-index film was 1.5 cracks were not formed. However, the refractive index was high at 1.47, and the film hardness was poor at “HB”.

In Comparative Example 4, the epoxy resin having a naphthalene skeleton was used as the binder component, but the colloidal silica particles in the silica sol only included spherical colloidal silica particles without including beaded colloidal silica particles. Therefore, even in a case where the thickness of the low-refractive-index film was 1.5 μm, cracks were not formed, and the film hardness was superior at “H”. However, the refractive index was high at 1.45.

In Comparative Example 5, the epoxy resin having a naphthalene skeleton was used as the binder component, and the colloidal silica particles in the silica sol included spherical colloidal silica particles and beaded colloidal silica particles. However, the silica sol and the epoxy resin having a naphthalene skeleton as the binder component were mixed such that the binder solid content was 2100 parts by mass with respect to 800 parts by mass of the SiO₂ content in the silica sol (SiO₂ Content in Silica Sol/Binder Solid Content=8/21). Therefore, even in a case where the thickness of the low-refractive-index film was 1.5 μm, cracks were not formed, and the film hardness was superior at “H”. However, the refractive index was high at 1.55.

In Comparative Example 6, the epoxy resin having a naphthalene skeleton was used as the binder component, and the colloidal silica particles in the silica sol included spherical colloidal silica particles and beaded colloidal silica particles. However, the silica sol and the epoxy resin having a naphthalene skeleton as the binder component were mixed such that the binder solid content was 1000 parts by mass with respect to 90 parts by mass of the SiO₂ content in the silica sol (SiO₂ Content in Silica Sol/Binder Solid Content=9/10). Therefore, even in a case where the thickness of the low-refractive-index film was 1.5 μm, cracks were not formed, and the film hardness was superior at “H”. However, the refractive index was high at 1.53.

On the other hand, in Examples 1 to 8, the low-refractive-index films were formed using the low-refractive-index film-forming liquid composition, in which the epoxy resin having a naphthalene skeleton in a molecular structure was used as the binder component, the silica sol in which spherical colloidal silica particles and beaded colloidal silica particles were dispersed in the liquid medium was used, and the SiO₂ content in the silica sol was 100 to 3000 parts by mass with respect to 100 parts by mass of the solid content of the epoxy resin (Sift Content in Silica Sol/Binder Solid Content=1/1 to 30/1). Therefore, cracks were not formed in the film having a thickness in a range of 0.6 to 2.0 μm, the refractive index of the film was low at 1.21 to 1.36, and the film hardness was high at H or higher.

### INDUSTRIAL APPLICABILITY

According to the present invention, a glass or film with a low-refractive-index film can be obtained by applying the low-refractive-index film-forming liquid composition to a transparent body such as a glass or a film to form a low-refractive-index film thereon. The low-refractive-index film is used as a display panel, a solar cell, an optical lens, a mirror, or eye glasses.

### REFERENCE SIGNS LIST

10: GLASS WITH LOW-REFRACTIVE-INDEX FILM
11: TRANSPARENT GLASS SUBSTRATE
12: LOW-REFRACTIVE-INDEX FILM
20: RESIN FILM WITH LOW-REFRACTIVE-INDEX FILM
21: TRANSPARENT RESIN FILM
22: LOW-REFRACTIVE-INDEX FILM

1. A low-refractive-index film-forming liquid composition comprising:
an epoxy resin (A) having a naphthalene skeleton in a molecular structure;
a silica sol (B) in which spherical colloidal silica particles and beaded colloidal silica particles are dispersed in a liquid medium; and
an organic solvent (C),
wherein a SiO₂ content in the silica sol is 100 to 3000 parts by mass with respect to 100 parts by mass of a solid content of the dried and cured epoxy resin.

2. A method of forming a low-refractive-index film, the method comprising:
applying the low-refractive-index film-forming liquid composition according to claim 1 to a transparent body surface.

3. A method of manufacturing a transparent body with a low-refractive-index film, the method comprising:
forming the low-refractive-index film on a body surface using the method according to claim 2.
